(19) United States
(12) Patent Application Publication
(10) Pub. No.: US 2023/0051345 A1
(43) Pub. Date: Feb. 16, 2023

(54) DETERMINING THE FLOW RATE OF A FLOWING FLUID

(71) Applicant: SICK AG, Waldkirch (DE)

(72) Inventors: Jens ALBRECHT, Waldkirch (DE); Mario KÜNZELMANN, Waldkirch (DE)

(21) Appl. No.: 17/884,779

(22) Filed: Aug. 10, 2022

(30) Foreign Application Priority Data
Aug. 11, 2021 (DE) 102021120883.1

(51) Int. Cl. G01F 1/66; G01F 1/684; G01F 1/34

(52) U.S. Cl. CPC G01F 1/66; G01F 1/6847; G01F 1/34

(57) ABSTRACT

A flow measurement device for determining the flow rate of a fluid flowing in a line is provided, wherein the flow measurement device has a measurement element arranged at a measurement point in the line for a selective detection of a measurement value of the flowing fluid, a control and evaluation unit to determine the flow rate from the measurement value, and a flow guidance element arranged upstream of the measurement point with respect to the direction of flow. In this respect, the flow guidance element supplies a representative portion of the flow to the measurement point.

The invention relates to a flow measurement device for determining a flow rate of a fluid flowing in a line and to a method of measuring the flow rate of a fluid flowing in a line.

Some of the different known technologies for the measurement of the flow velocity or of the flow rate of a fluid in a line are based on a selective measurement. The measurement thereby becomes particularly sensitive to different inflow conditions. FIG. 6 illustrates this for a line 100 on a measurement after an interference point, here in the form of a curvature, whereby the flow of the fluid 102 is deflected and disrupted as by the arrow 104. The measurement point 106 is downstream of the interference point.

A first flow profile 108 upstream of the interference point is still not disrupted and is symmetrical. A conclusion on the total flow cross-section can be drawn without problem here from a selective measurement. In a second flow profile 110 downstream of the interference point, the distribution of the local mass flow density is changed. Under the same assumptions as in the non-disrupted first flow profile 108, the conclusion from the selective measurement on the total flow cross-section would lead to a greatly differing measurement result. It is particularly problematic here that the second flow profile 110 is not known and is also not reproducible. The difference between the flow profiles 108, 110 therefore generates a measurement error, with measurement differences of ±50% and more easily being anticipated.

Such a selectively measuring process is the thermal or calorimetric flow rate measurement that is based on the different heat transfer of a flowing fluid in dependence on the flow velocity. Heating elements and temperature sensors are arranged in the flow for this purpose. The various known versions differ in the type of probes and their arrangement and in the measurement process.

A thin wire is used in hot wire anemometry. The method is suitable for fast local flow rate fluctuations at atmospheric pressure, but is very susceptible to contamination. Alternative designs of the probes in thin film technology provide greater robustness. Metallic probes are also known, but considerably increase the response time.

There are different regulation concepts with respect to the introduced heat. In the CCA (constant current anemometry) process, the heating element simply has a constant current applied and there is neither an electronic nor a thermal regulation. The CPA (constant power anemometry) process in which an electronic regulation of the heating power is provided is a somewhat more complex control. A disadvantage of this is that the heating element can overheat in the absence of heat removal in the case of a stationary fluid. In the CTA (constant temperature anemometry) process, both an electronic and a thermal regulation is implemented. The heating element positioned in the fluid flow is regulated to a defined overtemperature or temperature difference with respect to the temperature measurement of a separate temperature sensor. To be able to evaluate the temperature difference at all, the temperature at the heating element is additionally determined by an integrated further temperature sensor or by one arranged there. The mass flow is a function of the required heating power to maintain a required temperature difference between the heating element and the temperature sensor.

It has been shown in practical trials that in a calorimetric measurement using thin film technology, reproducible measurement results require ideal inflow conditions in an order of magnitude of 200 times the inner diameter of the line due to the measurement error described with respect to FIG. 6. This requirement is not given in a large number of installation situations.

The conventional replacement for a long, straight inflow path is the use of a flow guidance element. Different flow phenomena can be distinguished. In addition to the profile already illustrated in FIG. 6, the flow can have a swirl and can not least demonstrate a behavior that is variable in time and that under certain circumstances transitions into turbulence depending on the fluid, the flow velocity, and an obstacle. The flow guidance element is formed in dependence on the primary effect to be compensated as a flow converter or a flow straightener; a profile constriction is also possible.

The substantial pressure loss of conventional flow guidance elements to which the effect on the flow is coupled is disadvantageous thereon. A pressure loss ultimately has to be compensated at some point and thus continuously consumes energy. In addition, a certain calming path of the flow is required upstream of the measurement point with flow guidance elements in accordance with the prior art.

DE 10 2006 047 526 A1 discloses a flow straightener having a plurality of substantially rectangular guidance surfaces in a star-like arrangement, with the guidance surfaces having passage bores. A further flow straightener is likewise presented for an ultrasound measurement in EP 2 607 718 Bl. The geometry is more complex here with a plurality of webs alternately directed in the direction of flow and against the direction of flow. A constriction is moreover produced. EP 1 775 560 A2 shows a further variant of a flow straightener for an ultrasound flow rate measurement device. First and second straightener means are rotated oppositely to one another with the aim of thereby eliminating turbulence. All of these flow straighteners are designed for ultrasound measurements where the problem of an only selective measurement does not arise due to the ultrasound paths. The previously discussed disadvantages of the pressure drop are not addressed and are not solved.

A flow straightener for an ultrasound measurement device is known from DE 10 2008 049 891 B4. Due to an asymmetrical web arrangement, the flow cross-section is divided into a plurality of part cross-sections. A turbulent flow should be able to pass almost without disturbance while a laminar flow is swirled into a turbulent flow. Practically no pressure loss should thereby be produced and no secondary cross flows should be induced. However, a single measurement point to which the ultrasound method of DE 10 2008 049 891 B4 cannot be reduced in another respect could only be arranged in the flow that is always turbulent due to the flow straightener. In a fictive transition to a selective measurement process such as the calorimetric flow rate measurement, reliable, reproducible measured values would therefore not be achievable.

A flow limiter is described in US 2005/0039809 A1. Its function is to straighten a parabolic flow front. There are a plurality of vanes arranged in star shape for this purpose, with US 2005/0039809 A1 considering an approach that was earlier from its viewpoint and had an uneven spacing between the vanes as problematic and therefore homogenizing this arrangement. The measuring process of heat wire anemometry is mentioned in the introduction in US 2005/0039809 A1. The then presented geometries of the flow limiter are, however, drafted and described for a differential pressure measurement. In this respect, no fluid flows at the pressure pick up points so that it is not possible to speak of a flow guidance.

It is therefore an object of the invention to improve the measurement accuracy of a flow measurement device of the category.

This object is satisfied by a flow measurement device for determining the flow rate of a fluid flowing in a line and by a method of measuring the flow rate of a fluid flowing in a line in accordance with a respective independent claim. The measured value is frequently the mass flow. With a known fluid and a known line geometry, the mass flow, flow velocity, volume flow, or flow amount correspond to one another or can be converted into one another so that the “flow rate” is representative of these typical values that are measured by a flow measurement device. The region of the line in which measurement takes place is frequently replaced with the flow measurement device that is installed in the line. This difference is not looked at any further and the term line will continue to be used for simplification.

A measurement element arranged at a measurement point in the line selectively detects a measurement value of the flowing fluid. A control and evaluation unit uses the measurement value of the measurement element to determine the sought flow rate. Measurement point or selective detection mean that a measurement is only made at one point or, within a practical framework, only over a very small area. Only a very small local portion of the flow cross-section is therefore detected; no averaging over the flow profile takes place in the measurement itself. Contrary to this, ultrasound paths would, for example, not be selective or 0 dimensional, but rather at least 1 dimensional, with frequently a plurality of ultrasound paths being used to better map the flow cross-section.

A flow guidance element is arranged upstream of the measurement point with respect to the direction of flow of the fluid. Conventionally, such a flow guidance element would, as discussed in the introduction, provide a reproducible and uniform flow and so-to-say create conditions such as in a fictive installation situation as if a longer, straight and non-interrupted inflow path preceded the flow measurement device. In accordance with the invention, the flow guidance element has a different function as presently explained.

The invention starts from the basic idea of providing a measurement situation at the measurement point that is representative of the flow profile. The flow guidance element is designed such that it supply portions of the flow to the measurement point that are also representative of the remaining flow. The flow as a whole is here left as unchanged as possible; a calming or the like of the total flow is explicitly not aimed for and not achieved. The flow guidance element acts as a kind of flow pickup by which said representative portion of the flow is excised and is conducted to the measurement point. A local mass flow density can therefore be measured as representative of the total flow profile at the measurement point. Without the flow guidance element in accordance with the invention, only the very small inner part flow that can in particular display substantial differences and fluctuations with respect to an assumed average flow downstream of an interference point and that impacts the measurement point would be detected there. This was explained in the introduction with reference to FIG. 6.

The invention has the advantage that a considerably reduced sensitivity is also achieved with respect to unfavorable inflow conditions. An expanded uninterrupted inflow path whose length would easily have to amount to more than 200 inner diameters in accordance with the discussion in the introduction is no longer necessary. In this respect, however, no attempt is made as with conventional flow converters or flow straighteners to calm the flow as such so that it behaves as if this inflow path were present. It is rather the case that only a small, but representative portion of the flow is picked up and influenced. Accordingly, in accordance with the invention, only a substantially reduced pressure loss occurs. A physical averaging of an asymmetrical flow profile takes place at the measurement point so that the measurement becomes substantially more accurate thanks to the flow guidance element in accordance with the invention.

The measurement element preferably has at least one heating element and at least one temperature sensor for a calorimetric flow rate measurement. A calorimetric flow measurement device is thus produced. This is a widespread and simple process that only measures selectively. The measurement process can also be called a thermal flow rate measurement or thermal anemometry, with some more specific designs having been briefly sketched in the introduction. The at least one temperature sensor can be integrated in the at least one heating element or can be arranged as a separate component at the heating element. The flow rate is determined from the temperature and/or from the heating power or form a value derived therefrom.

The control and evaluation unit can be configured in dependence on the embodiment to apply a constant current to at least one heating element to regulate its heating power per se or to regulate its heating power such that the temperature at the heating element differs by a predefined temperature difference from the temperature information of the at least one temperature sensor. This corresponds to the conceivable versions explained in the introduction of the CCA (constant current anemometry) process, the CPA (constant power anemometry) process, and the CTA (constant temperature anemometry) process.

The at least one heating element and/or the at least one temperature sensor is/are particularly preferably produced in thin film technology. Favorable and simultaneously reliable and robust components are thus produced that enable a reproducible heating or temperature measurement.

In an alternative embodiment, the measurement element has a pressure measurement element. This is another example of a flow rate measurement that is based on a selective measurement at a measurement point. The flow measurement device is, for example, formed as a pitot tube or as a pitot probe.

The measurement point is preferably arranged within the flow guidance element or follows on directly from the flow guidance element. In accordance with the invention, unlike with conventional flow converters or flow straighteners, no or at least only an extremely short downstream calming path is required.

The flow guidance element preferably has at least one aperture to allow a portion of the fluid to pass that is complementary to the representative portion and that is uninfluenced. Only a representative portion of the flow is supplied to the measurement point in accordance with the invention. The remaining flow preferably remains uninfluenced and simply flows through the at least one aperture. A flow influencing or a flow-calming flow overall is not aimed for at all. Since an uninfluenced portion of the fluid is allowed through, the pressure drop can be kept particularly small.

The representative portion preferably corresponds to at most 75%, at most 60%, at most 50%, at most 40%, at most 30%, at most 25%, at most 20%, at most 10%, or at most 5% of the cross-section of the flowing fluid. The representative portion is quantified by these numerical values, i.e. which representative portion of the cross-section of the flow is directed to the measurement point and which complementary, uninfluenced portion is simply allowed through. The uninfluenced portion is preferably predominant for a pressure drop that is as small as possible, under the condition that the representative portion still maps the flow profile sufficiently. Further portions, caused by wall thicknesses of the flow guidance element, for instance, are neglected here.

The flow guidance element preferably has a plurality of arms that are arranged in spoke form and that have guide slots for picking up the representative portion. The arms preferably extend radially over the whole line cross-section and thus detect the total flow profile in the radial direction. Different peripheral directions of the flow profile are taken into account by a plurality of arms. This provides that the representative portion can actually be representative of the complete flow profile.

The guide slots are preferably continued in the longitudinal direction of the line as guide channels to the measurement point. The guide slots designate the inlet for the representative portion in a frontmost region of the flow guidance element directed into the flow. Guide channels having this respective inlet are formed within the flow guidance element, in the direction of flow; they transmit the different received part flows of the representative portion and open together in the measurement point, with them also already being able to be merged earlier.

The flow guidance element preferably has four arms arranged to form a cross. The arms are imagined as starting from a center that is preferably, but not necessarily, central in the line cross-section. This geometry is a good compromise to conduct a representative portion to the measurement point and to leave large apertures free from a complementary, uninfluenced portion. In addition, a preferably regular cross having arms that extend at least approximately perpendicular to one another has special advantages because it maps the flow well in both main radial directions, in particular with an arrangement of the flow measurement device after a 90° curvature of the line.

The flow guidance element preferably has a plurality of support elements at an offset angle from the arms, in particular in each case a support element centrally between two arms. The support elements serve the mechanical stabilization of the flow guidance element in the flow. They should take up as small a flow cross-section as possible with a still sufficient strength. With a central arrangement between two arms, the flow remains largely unchanged as desired. In a cross arrangement of the arms, for example, the supports form a further cross that is rotated by 45°. Unlike the arms, the supports do not have any guide slots or guide channels, they do not contribute to picking up the representative portion of the flow.

The flow guidance element preferably has a central blocking element. The central blocking element is disposed just upstream of the measurement point and blocks a direct onflow of the measurement point. Otherwise, a central, direct part flow to the measurement point could dominate the representative portion in an unwanted manner. In an embodiment of the flow element with arms, the blocking element preferably forms its geometric center.

The flow guidance element preferably has a central guide channel toward the measurement point. The central guide channel is preferably disposed behind the central blocking element so that fluid cannot flow directly in here. Guide channels originating from the arms preferably open into the central guide channel.

The measurement point is preferably arranged off center. The front side of the flow guidance element is preferably still symmetrical to a longitudinal center axis of the line. This symmetry does not have to be maintained within the flow guidance element. A measurement element at an off center measurement point that therefore has a radial offset from the center of a line cross-section is easier to reach and connect from the outside. It is alternatively possible to design the flow guidance element as symmetrical overall. This is possibly still more favorable from a technical flow aspect, but the measurement element then has to be disposed centrally and to be connected accordingly.

The guide channels are preferably not formed as symmetrical to a longitudinal center axis of the line. As just mentioned, the symmetry can be canceled within the flow guidance element. The guide channels thus reach an off center measurement point despite a design of the flow guidance element still symmetrical at the frontmost side.

The flow guidance element is preferably formed symmetrical to the center of the line cross-section in a first cross-section presenting itself to the inflowing fluid. This again repeats the advantageously property of a symmetrical front side of the flow guidance element. Specifically with an embodiment having a cross with four arms, a geometry thus results overall of a regular, centered cross in the first cross-section presenting itself to inflowing fluid. The one arm is then shortened and the other extended on the one diameter within the flow guidance element or its functional channels take a corresponding course. In the other two arms on the diameter transversely thereto, the guide channels have a common component directed to the measurement point.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

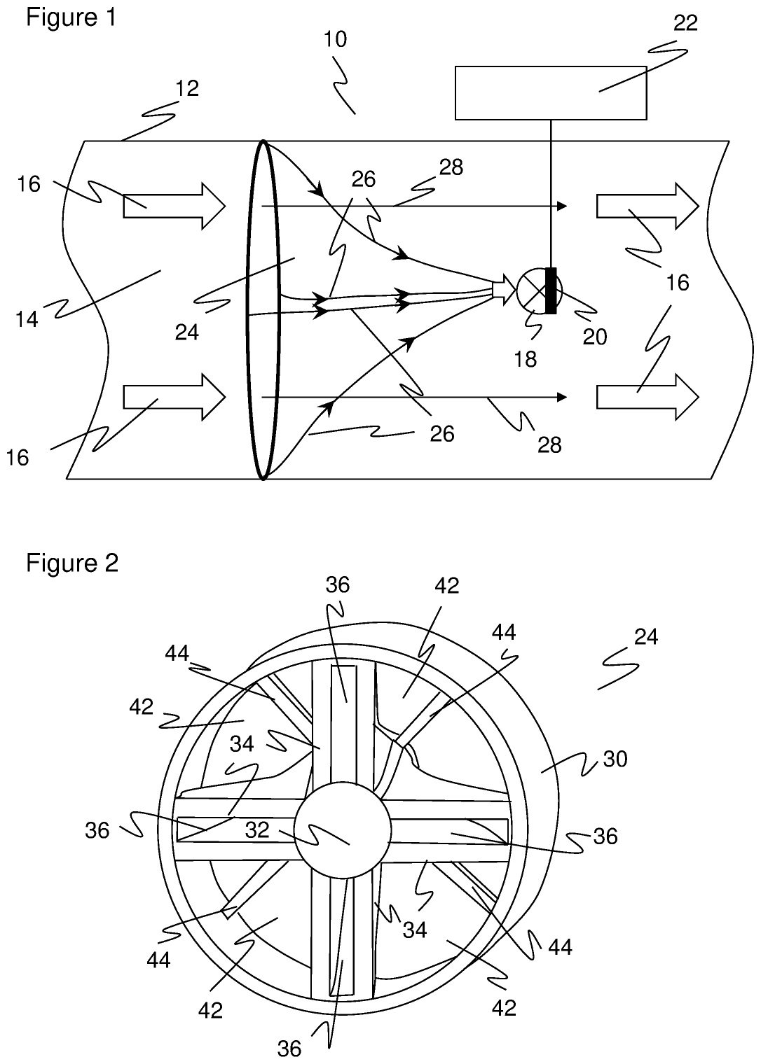

FIG. 1 a schematic overview representation of a flow measurement device in a longitudinal section of a line with flowing fluid;

FIG. 2 a front view of a flow guidance element;

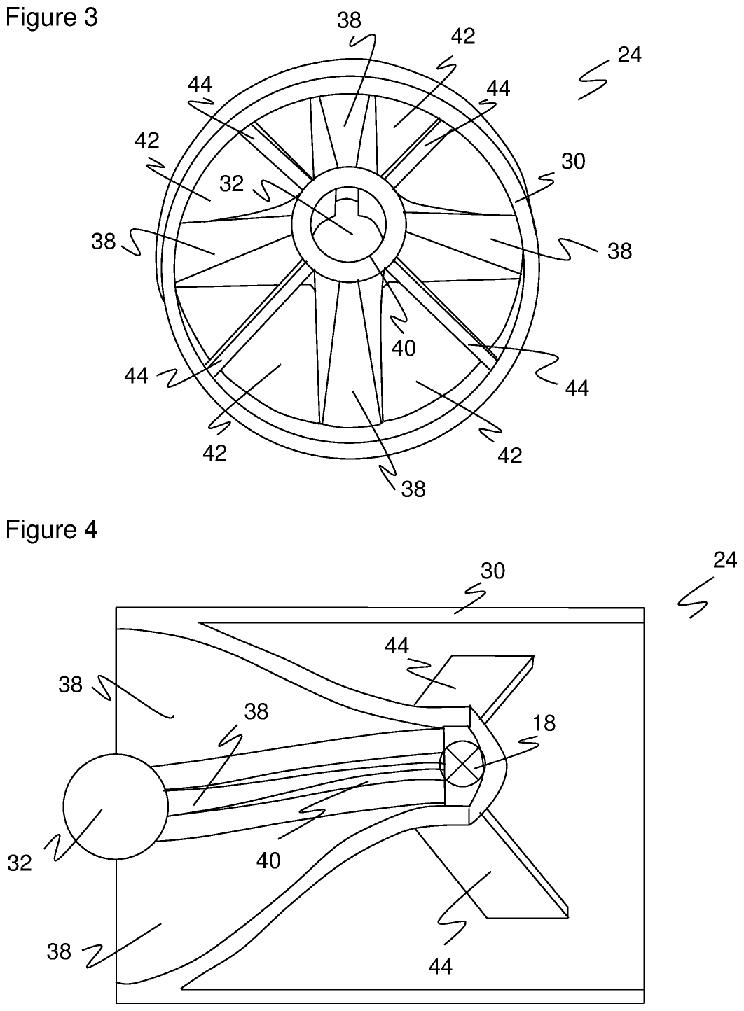

FIG. 3 a rear view of the flow measurement device;

FIG. 4 a longitudinal section of the flow guidance element in an upright sectional plane;

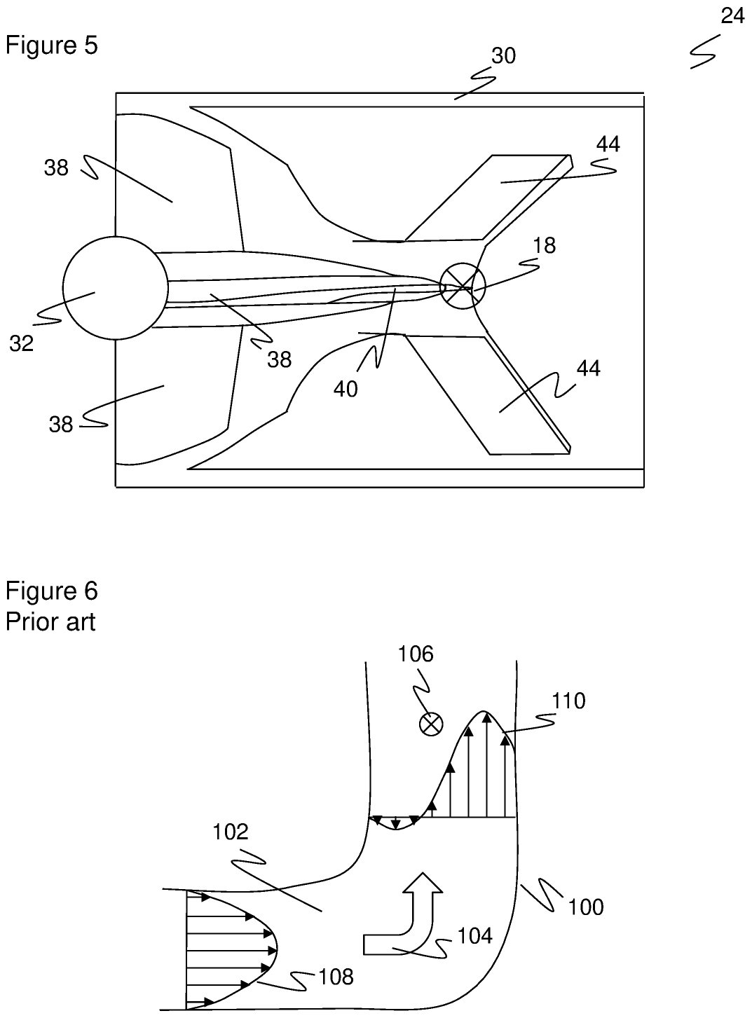

FIG. 5 a longitudinal section of the flow guidance element in a horizontal sectional plane that is tilted by 90° against the upright sectional plane of FIG. 4; and

FIG. 6 a sketch to illustrate measurement errors with a selective conventional measurement without a flow guidance element in accordance with the invention.

FIG. 1 shows a flow measurement device 10 in a longitudinal sectional representation of a line 12 in which a fluid 14 flows in the direction of flow marked by arrows 16. A measurement element 20 is arranged at a measurement point 18. A measurement value of the fluid 14 is determined by it that is evaluated in a control and evaluation unit 22. Different technologies are known by which the flow velocity or the flow rate of the fluid 14 can be determined by a selective measurement. Selective measurement means that measurement only takes place at the measurement point 18 so that the flow profile over the cross-section of the line 12 is only detected at a single point. It is not precluded here to arrange a plurality of measurement elements at a plurality of measurement points, but this multiplication of the measurement effort should preferably be avoided, that is there should only be the one measurement point 18 with the one measurement element 20.

The example looked at in more detail here of a selective measurement is the thermal or calorimetric flow rate measurement. A further alternative named by way of example is a flow rate measurement using the pressure or a pressure drop. The thermal flow rate measurement has already been briefly presented in the introduction; the flow measurement device 10 can in this respect be formed as in the prior art. The measurement element 20, for example, has a substructure hang at least one heating element and at least one temperature sensor that are preferably manufactured in thin film technology. The control and evaluation unit 22 is connected to the at least one heating element and the at least one temperature sensor to evaluate the temperature measurements, to control the heating power, and to determine a flow velocity or a flow rate of the fluid 14. In principle every known method can be considered for a thermal flow rate measurement. For example, in a CTA (constant temperature anemometry) process, the heating element is regulated to a fixed overtemperature with respect to the temperature at the temperature sensor. In other words, the temperature of the unheated fluid 14 is measured by the temperature sensor and a certain difference temperature thereto is specified as the control variable at the heating element. The heating power required for this can be converted into a flow rate using a characteristic.

In accordance with the invention, a flow guidance element 24 is arranged upstream of the measurement point 18; it Is only shown schematically in FIG. 1 and will be explained more exactly with reference to FIGS. 2-5. The flow guidance element 24 conducts a representative portion of the flow to the measurement point 18, as indicated by arrows 26. Representative portion means, on the one hand, that this portion is representative of the total flow so that an averaging effectively takes place over the flow cross-section thanks to the flow guidance element 24. The only selective measurement is thereby also able to detect a flow rate of the flow as a whole even with an irregular, unknown, or variable flow profile. On the other hand, it is only a portion of the flow; a further complementary portion flows through the flow guidance element 24 and in particular past the measurement points 18, as indicated by arrows 28, at least largely uninfluenced. The pressure loss of the flow guidance element 24 is thereby restricted.

FIGS. 2 to 5 show different views of the flow guidance element 24 by which its geometry and function will now be explained in detail. FIG. 2 here is a front view, FIG. 3 a rear view, FIG. 4 a longitudinal section in an upright or vertical sectional plane and FIG. 5 a longitudinal section in a sectional plane lying perpendicular or horizontal thereto.

The flow guidance element 24 is surrounded by a cylindrical frame 30 whose outer diameter corresponds to the inner diameter of the line 12. In the front cross-sectional area, that is the front best recognizable in FIG. 2 with an orientation toward the onflowing fluid 14, a central blocking element 32 is provided that does not allow any fluid 14 to flow through on the center longitudinal axis of the line 12. A plurality of arms 34 extend radially outwardly from the central blocking element; in the preferred embodiment shown, four arms 34 in a cross having right angles between the arms 34. The arms 34 have guide slots 35 toward the front through which fluid 14 can flow into the arms 34. For this purpose, the guide slots 36 are continued within the arms 34 in the further extent of the flow through guide channels 38 that can be seen in FIGS. 3 to 5. The guide channels 38 open in a central guide channel 40 that ends at the measurement point 18.

The front side of the flow guidance element 24 is preferably symmetrical with a centrally arranged central blocking element 32 and arms 34 of equal length of a regular cross in this cross-sectional plane. The measurement point 18 is, however, offset off center in the embodiment shown without restricting the universality due to a possible rotation of the line 12 toward the top so that the measurement element 20 becomes more easily accessible. The central guide channel 4 thus does not remain on the central longitudinal axis, but rather evades upwardly toward the measurement point 18. The upper one of the arms 34 is accordingly shorter on the upright diameter along the flow guidance element 34 and the lower one of the arms 34 is longer. In the two arms 34 arranged transversely thereto, the guide channels 38 travel upward, as can be recognized in FIG. 3. The described and shown asymmetry is only one conceivable embodiment. Alternatively, the measurement point 18 can be arranged centered, that is it can lie on the center longitudinal axis of the line 12. The measurement element 20 then as to be arranged and connected at the center.

The flow guidance element 24 has apertures 42 through which the fluid 14 can flow in an uninfluenced manner between the arms 34. As can be recognized in FIGS. 2 and 3, the common area of these apertures 42 makes up a large portion of the cross-sectional area of the tine 12. A balance between a sufficiently representative portion of the flow that is picked up through the guide slots 36 in the arms 34 and a pressure loss through large openings 42 that is as small as possible can be found here. Support elements 44 are arranged in the apertures for an improved mechanical stability. They likewise take up as little cross-sectional area as possible with sufficient strength. A central arrangement within the apertures 42 has the smallest influence on the flow. The support elements 44 thus likewise form a cross, like the arms 34 and rotated by 45° thereto, in the preferred embodiment shown.

The flow guidance element 24 picks up partial cross-sections of the flow profile by means of the guide slots 36 and conducts these partial flows to the measurement point 18 by means of the guide channels 38 adjoining the guide slots 36 and by means of the central guide channel 40. The geometry of the guide slots 36 is selected such that the partial flow conducted to the measurement point 18 is representative for the total flow cross-section. The guide slots 38 extend radially over the total line 12 and a plurality of radial partial flows are picked up over the plurality of arms 34 in the peripheral direction. A good averaging thus takes place. At the at the same time, the guide slots 36 do not become too large. This would have the result that the flow accelerates by an unwanted amount at the measurement point 18. In addition a large pressure drop of the flow downstream of the flow guidance element 24 would be caused overall since then the apertures 42 through which the fluid 14 can flow without impediment would adopt too small an area in comparison with the guide slots 36.

Alternatively to the off center measurement point 18 explained up to now, a central arrangement thereof is likewise conceivable. This supports an uninterrupted flowing past of the flow portions flowing through the apertures 42. The interference effect is, however, also restricted with an off center measurement point 18, at least for so long as the front side remains in a symmetrical design and the offset from the center relative to the radius of the line cross-section remains small.

The situation shown in FIG. 6 with a 90° pipe curvature before the measurement point occurs very frequently in practice. The flow measurement device 10 would otherwise be oriented obliquely in space. Such a 90° curvature produces in a first approximation an offset of the center of the flow likewise in a 90° pattern. This is a reason why a cruciform arrangement of arms 34 in a reciprocal right angle is particularly advantageous.

It could be demonstrated in simulations that the partial flow picked up by the flow guidance element 24 and conducted to the measurement point 18 is actually representative, that is, for example, averaged after a 90° curvature of the line 12 over the flow profile. A very considerably smaller pressure loss is achieved here than would be possible with conventional flow converters that are directed to calming the total flow.

1. A flow measurement device for determining the flow rate of a fluid flowing in a line, wherein the flow measurement device has a measurement element arranged at a measurement point in the line for a selective detection of a measurement value of the flowing fluid, a control and evaluation unit to determine the flow rate from the measurement value, and a flow guidance element arranged upstream of the measurement point with respect to the direction of flow,
wherein the flow guidance element supplies a representative portion of the flow to the measurement point.

2. The flow measurement device in accordance with claim 1,
wherein the measurement element has at least one heating element and at least one temperature sensor for a calorimetric flow rate measurement.

3. The flow measurement device in accordance with claim 1,
wherein the measurement element has a pressure measurement element.

4. The flow measurement device in accordance with claim 1,
wherein the measurement point is arranged within the flow guidance element or follows on directly from the flow guidance element.

5. The flow measurement device in accordance with claim 1,
wherein the flow guidance element has at least one aperture to allow an uninfluenced portion of the fluid complementary to the representative portion to pass.

6. The flow measurement device in accordance with claim 5,
wherein the representative portion corresponds to at most 75%, at most 60%, at most 50%, at most 40%, at most 30%, at most 25%, at most 20%, at most 10%, or at most 5% of the cross-section of the flowing fluid.

7. The flow measurement device in accordance with claim 1,
wherein the flow guidance element has a plurality of arms arranged in spoke form and having guide slots for picking up the representative portion.

8. The flow measurement device in accordance with claim 7,
wherein the guide slots are continued in the longitudinal direction of the line as guide channels to the measurement point.

9. The flow measurement device in accordance with claim 7,
wherein the flow guidance element has four arms arranged to form a cross.

10. The flow measurement device in accordance with claim 7,
wherein the flow guidance element has a plurality of support elements at an angle offset from the arms.

11. The flow measurement device in accordance with claim 10,
wherein the flow guidance element has in each case a support element centrally between two arms.

12. The flow measurement device in accordance with claim 1,
wherein the flow guidance element has a central blocking element.

13. The flow measurement device in accordance with claim 1,
wherein the flow guidance element has a central guide channel toward the measurement point.

14. The flow measurement device in accordance with claim 1,
wherein the measurement point is arranged off center.

15. The flow measurement device in accordance with claim 8,
wherein the guide channels are not formed symmetrical to a central longitudinal axis of the line.

16. The flow measurement device in accordance with claim 1,
wherein the flow guidance element is formed in a first cross-section presenting itself to the onflowing fluid symmetrical to the center point of the lone cross-section.

17. A method of measuring a flow rate of a fluid flowing in a line in which a measurement value of the flowing fluid is selectively detected at a measurement point by a measurement element arranged in the line and the flow rate is determined from the measurement value, wherein the flow is varied by a flow guidance element upstream of the measurement point,
wherein the flow guidance element supplies a representative portion of the flow to the measurement point.
